(19) United States
(12) Patent Application Publication
(10) Pub. No.: US 2012/0153758 A1
(43) Pub. Date: Jun. 21, 2012

(54) Pulsating Permanent Magnet Engine

(76) Inventor: Lloyd George Perry, Fort Wayne, IN (US)

(21) Appl. No.: 13/261,188

(22) PCT Filed: Sep. 1, 2010
(86) PCT No.: PCT/US10/02389

§ 371 Date: Feb. 23, 2012

Related U.S. Application Data
(60) Provisional application No. 61/275,652, filed on Sep. 1, 2009.

(51) Int. Cl. H02K 21/00

(52) U.S. Cl. 310/152

(57) ABSTRACT

The Pulsating Permanent Magnet Powered Engine was designed and built as a new energy source by harnessing the strong magnet fields developed by magnets. Emphasis added when using Rare Earth Neodymium magnets. In this development the need to insulate, isolate and contain those magnet force fields became a challenge. This lead to the development of the bellcrank system. To gain horse power, the rating requires moving 550 pounds at a rate of 1 foot per second. The bellcrank system enables both the distance and the pound requirements to be met as qualifications for horse power. The principles of thermodynamics, stated as power in and power out do not apply here. Permanent magnets are charged with a very high electrical current, much like charging a battery but the battery power depletes with use, while the magnet does not, but both were charged to begin with.

This nonprovisional U.S. utility patent (26 pages) is a set of claims established by a provisional U.S. patent filing Sep. 1, 2009 under Number U.S. 61/275,652, by LLoyd G. Perry, a U.S. citizen, residing in the State of Indiana, County of Allen, in the city of Fort Wayne.

### BACKGROUND OF THE INVENTION

There was no Government funding nor assistance given related to this invention.

In search of pre-existing patents under the title of permanent magnet motors or engines, produced several un-related types of motors none of which were at all similar to this instance engine now being applied for as a nonprovisional patent. That is to say, one has a similar title but that is where it ends.

On Apr. 24, 1979 Howard R. Johnson received a patent on a permanent magnet motor. U.S. Pat. No. 4,151,431. While the reading of the description and viewing of the drawings are interesting, those of us that know this technology know that that motor could not have worked nor could any of the described methods of making permanent magnet motors, stated within his background statement. I don't know how the patent was issued on something that didn't work but for certain it was issued.

Johnson used metal shields for directing magnetic waves where more than one permanent magnet was at, that makes rotation impossible because the metal attracts the un-shielded magnets.

There are several different claims on the internet, with short moving pictures, but they lack details and do not show the entire area around the motor, leaving the impression that the rotation is assisted with some outside source of power. No patent is associated with them.

The problem with this type of engine in past models, is in the fact that while rotation can be achieved, the power level is to low to be called anything but perpetual motion. That fact distinguishes this pulsating permanent magnet powered engine, that is the subject of this patent application, from any and all others of a similar name or type of function. The difference is in the method by which the power is made available. To achieve high horsepower this method requires high torque, applied in foot pounds of pressure, in the form of repelling forces, that can be calculated the same as any type of horsepower.

Knowing the magnets is an essential that can not be by-passed. Knowing these facts are necessary to make it all work. (a.) the power of the magnet you are going to use, rated in holding force; (b.) test those magnets by setting them opposed to one another, with like poles facing each other and then opposite poles facing each other. Do this test by dangling a small, light needle on a piece of thread, in the area between the two magnets. Move the magnets out or apart so that there becomes a point where the magnet from either side will not draw the needle toward it nor push it away from it. You need about one inch center margin as room for the needle to move without being effected. This establishes the distance or reach of the magnetic fields so that in your spacing of the magnets on your magnet disc and in the magnet carrier hooks,(on a required streight line measure from magnet to magnet on the disc, not the arc of the disc.) there will be no interference from one magnet field by any other. All magnets have a distance of this type and you must test them. At the same time, you can not mix sizes without this same test. (however stacking of magnets and other supplimental methods can change the power at the stacked point) (c.) any materials or parts used around the magnets, within the distance you have now determined as the magnet field must be totally non-magnetic. (outside that range magnetic materials can be used.) The smallest set screw or washer or anything else that will draw a magnet can not be used in the area where these magnet clusters are at. It will lock the rotation. (d.) now take the magnets you are going to use, in your hands and with caution and holding tight, put the two magnets up to each other with the same poles of both magnets facing each other. This will cause the magnets to repell each other and that will show you several very important factors that will help you know how to get the most power out of your magnets.

The preferred magnet sizes are the 40 pound and 15 pound rare earth neodymium. Smaller is hard to overcome friction loss; larger makes the engine very large but very powerful. Round magnets or magnets with holes in them are very very hard to manage.

In the alternative the use of combined permanent magnets with electro magnets to achieve the desired power range, can be used. Any combination or mix of permanent magnets or electro magnets or both are useable when properly timed. Distance is still a factor.

When you put your magnets up to each other, you find that the closer they get the harder they are to make them get closer together. In fact you can not put them together without some device to help you. As said, the closer they get the harder they push back. This fact makes the need to pivit the end of the magnet arm, with the magnet installed, so that the faces of the arm magnets to the faces of the disc magnets (two opposing magnets) can stay flat surface to flat surface thru the greater part (60%-80%) of the push or stroke. The normal shift of the magnets position of up and down during the stroke cycle, will cause only a small loss of power as long as at least one quarter of the surfaces of each opposing magnet remains in face to face contact. (rectangular shaped magnets give more room to shift, thus allowing for a longer stroke.)

Think about that fact and consider that if you had 2 discs rotating in the fashion of 2 meshed gears, you would have two magnets comming together for a split second with a lot of power. This, in very simple terms, is what happens in the perpetual motion motors. The split second passing is the culprit that costs the power loss. This factor and it's corrections are some of several things that this magnet engine uses to turn the perpetual motion motor into a new energy source in motors.

To get the maximum power from those magnets you must first bring those magnets tight together so that they will actually touch. Then keep them together for as long as the rotation of the magnet disc will allow that union before it falls away as a normal event from the rotation of two opposing disc (two opposing arcs) rotating in a circular motion.

The process to get the desired effect is in a very complicated timing system. Starting with the main shaft, use a main shaft gear that will allow the gear ratio to be equal to the number of magnet lobes on the magnet disc so that if you use three lobes the divisable numbers would be odd numbered. If you use 4 or more that are divisable by two the numbers will be even. (The more lobs the larger the disc diameter because of the required streight line distance.) Combining with electro magnets does not change these timing needs. Using only electro magnets does.

For example, 4 lobes has you using a main shaft gear with the pitch diameter of 4 inches. You want a ration of 4:1 on the counter gears so your gear pitch for the counter shafts are 1 inch. (pitch diameter of each.) Mounted on that counter shaft is a disc (this disc is eleminated in the internal and external cam models) that has three sets of holes in the radius that runs from the outside edge of the disc back toward the center of the disc. Those holes are for a pivit pin that fastens a drive arm from that disc pivit point over to a pivit pin on a unit that is called a bell crank. The bell crank is then tied to that drive arm from the counter shaft disc. The bell crank is a segment cut out of a gear in the shape of a bell. That bell gear is a 3 inch pitch matched to a small gear on the drive rod (shaft) of 0.75 pitch or a ratio of 4:1. (this even numbered ratio will change if you extend the carrier arms for a longer stroke.) The same principles are apply with electro magnets.

To gage the length of the stroke needed to span the measured direct line distance, divide that distance by the number of magnet carrier disc and allow plenty of overlap as a total of combined strokes per quarter turn.) On cam models, this ratio will be figured to make your cams, cause the dwell points, plus determine arm length for desired stroke distance, times number of disc.

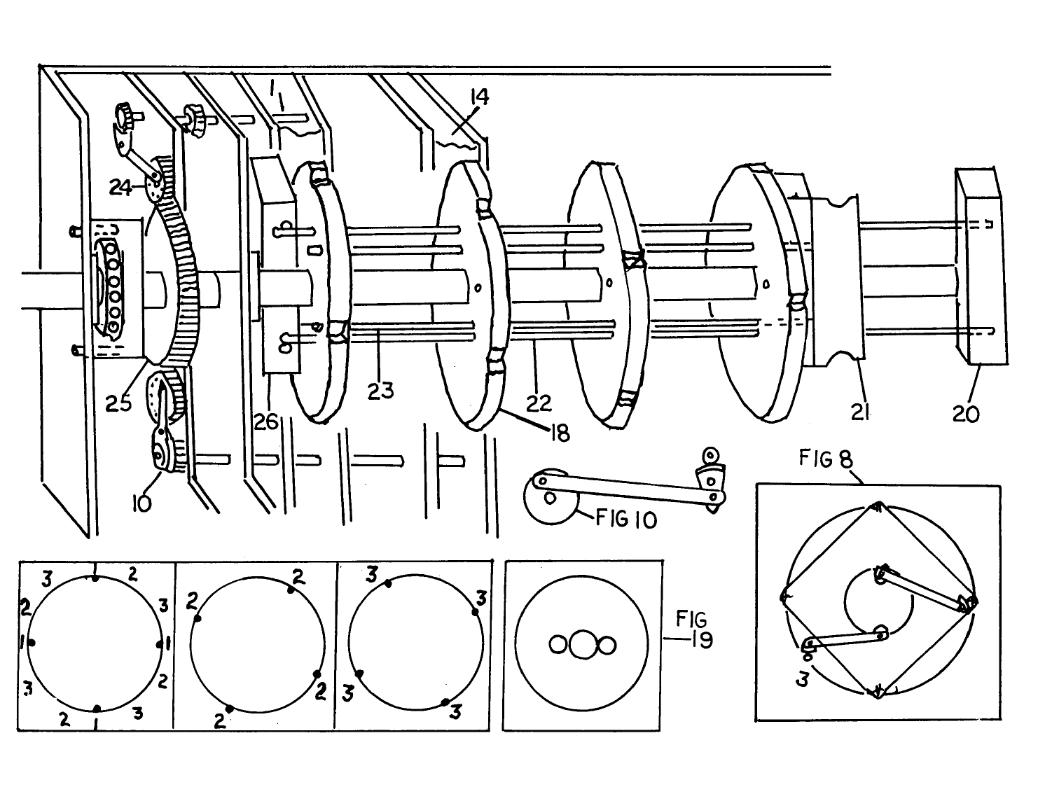

Going back to the counter shaft and it's disc, you see that the drive arm pivit causes the arm connecting the bell crank to oscillate. This is very very important and this is where the engine gets it's name “pulsating”. (On the internal and external cam models, that disc is replaced by a cam follower) Without this system and it's oscillating action this engine would be just another perpetual motion motor. (see drawings page 4, FIG. 10) (a bell crank system or some similar method of causing the oscillation is vital to generating the power needed. The methods vary with engine styles such as internal cam vs. chain drive and even when using electro magnets) However this system is timed so that on a 4 magnet lobe disc, contact with the carrier arm magnets (all 4) will make contact at the same time with the magnet disc magnets (all 4) and each set four times (at each ¼ turn) in each revolution of the engine. Since all 4 lobes of each disc are moving at the same time, the incremental progression is accomplished by the 4 discs moving, not indivigual magnet movement, so as to have all the lobes on two discs under full power and a third disc part way under power at all times. The distance between the lobes is calculated so that the length of the magnet carrier arms will be timed to give a full length push with an overlap of the required traveled distance. The power in this system is gained here. It can be compounded by using electro magnets and stacking magnets.

The requirement of work as in the horsepower formula of 550 pounds, moved one (1) foot per second, equals total applied pounds, times the R.P.M.s divided by 550 gives horsepower from pounds of force. The distance converted from inches to feet gives the distance of the work preformed based on R.P.M. in a corresponding time period used in the pound formula.

Starting with the magnet carrier arms in a dwell position, pointing up at about 10 o'clock in the crossmember sections, is one advantage to the system for timing. This position is called the neutral position (there is no real neutral) because it allows the magnets on the magnet disc to pass under the magnets on the magnet carrier arms with no effect on either magnet. (This will vary when electro magnets are used on the arms.) That point is also called a dwell point in the oscillation cycle and allows the momentary delay that allows the said neutral to happen. At the time in which the magnet disc is positioned so that the magnet carrier arm can start it's run in a swing of about 112°-150°, the magnet carrier heads toward the magnet disc at a very high speed so as to be able to catch the disc and get up tight against it. The magnets stay tight against, face to face to gain full force pushing power. With this action the force of the magnets repelling is extended by about 3 times it's normal push. The intent is to put the magnet carrier into a slight over run of the magnet disc so as to keep optimum pressure between the magnets, thus full power push over the entire contact distance. Electro magnets require the same functions as do permanent magnets when used alone.

Then comes the dwell on that other end of the oscillation, (112°-150° swing) which holds the magnet carrier just briefly at the end of it's swing. This is again a big plus because while the magnet carrier is holding still at point of dwell, the magnet disc is still turning but it is still under push pressure because the normal range of the magnet push is still well within it's magnet force range. It is important to match that point of dwell to the length of stroke so that maximum power is achieved by calculating the exact optimum of dwell. This could change the degrees of swing to be more or less than the 150°. (depending on the size magnet, the push could be extended by as much as 3 inches but with reducing power as the gap widens.)

So when you compare the effects of the 2 meshed gears and their brief push of possibly ½ inch, to the extended push of the pulsating system of about 2¾ up to 6 inches and greater, with that push being under full pressure for about 70% of that swing. This translates into lots of power. The length of stroke with pulsating effects, incrementally progressive timing of the discs, you have power full distance between lobes, maximum pressure to force rotation, and develop stall torque. When you supplement the permanent magnets by stacking or with electro magnets it is even stronger and in some ways more manageable. Regulating the power of the electro magnets, adjusts for excessive drag.

If your choice is a 40 pound magnet you have two disc with 8 sets of 80 pounds or 640 pounds plus one disc at half power would equal 160 plus 640×4 times, per revolution equals 3200 lbs. times the speed (1750 RPM) equals 5,600,000 pounds divided by 33,000 equals 169.69 HP. (changing gear ratios in the bell crank can change R.P.M.s from 500 to 3000 and again increasing horsepower.) Then you consider that this is the same as an electric motor, constant speed and all, which compared to gas or diesel of the same horsepower, it would take 3.5 times more H.P. of the gas or diesel or 593.93 HP to equal it. There is also the advantage of stall torque because of the magnets always being powered up with no gap between strokes. Again you are greatly increasing your power with the use of the electro magnets in combination with the permanent magnets. This system will work with electro magnets alone as it does with permanent magnets alone.

If there is a dis-advantage in this engine it is in the facts that the magnetic field distance requires the gear boxes to be mounted on each end, if magnetic materials are used for gears and chains or cams. Otherwise a center drive of non-magnetic gears may be used. The internal and external cam models also drive this way or with a common stub main shaft drive.

All in all the fact that the engine is constant speed requires the use of an electro-stat or hydro-stat unit to give a variable speed in applications such as automobiles that require a variable speed. Hydraulic is the preferred choice with a hydraulic pump driven off of any accessory drive gear, it would power a high speed hydraulic drive motor, which is then controlled by a spool valve to give the same effect as an accelerator pedal. This is not shown at this time but will be added later in a dependant application. Variable speed units could also be used as could many other ways. The electro stat would use a power generating system and reastats for speed control. If you are using the electro magnets there will need to be a battery system to accomidate their use along with a computer system or a carbon brush and commentator system, one or the other. However the electrical type of system would have this engine as the power source for a high voltage generator and battery system and feed a direct electric motor installed per wheel on drive wheels in motor vehicles of any types including trucks and jet aircraft.

### BRIEF SUMMARY OF THE INVENTION

This engine gets it power from permanent magnets of the form of Rare Earth Neodymium from 8 pounds up to 180 pounds of holding force. The engines can range in power from about 15 horsepower, up into the thousands of horsepower. None of which requires any type of fuel or electrical/battery to operate on. The ideal sizes of magnets to use are the 40 pound and 15 pound.

While this above paragraph is true, in development of this engine, it was found to be very beneficial to use electro magnets in various ways to assist in powering up the engine. Electro magnets together with permanent magnets on the carrier arms or on the carrier disc and even using permanent magnets on one (arm for example) and an electro magnet on the carrier disc works well. Or visa versa. The function of the bell crank mechanism allows for a lot of versatility and still function well even with a streight line application of electro magnets that use the same bellcrank mechanism but with just electro magnets.

Past uses of magnet powered engines have failed due to lack of power, thus being dubbed perpetual motion motors. This engine is not in that class with it's pulsating system. It makes the term perpetual motion a term that will not be used with this engine. Keep in mind that without applying the conditions as set forth above, steps listed as (a.) thru (d.) this power will not develop. As a comparison look at drawings on page 4 and at FIG. 10, specifically 10-E which is a normal drive arm compared to 10-D and 10-C, which is the bell crank that gives the control of the speed of the magnet carrier drive rod, adjustable by changing the location of the drive arm pivit point shown in 10-A. The oscillation effect of 10-A and it's various versions, are only ways to develop the neutral as well as extend the full pressure contact push. It aids in the parting push for an over-lap of power by the extended push. Thus spanning the entire distance between lobes, per quarter section when combined with the pulsating progressive rotation of all four discs. I say oscillating effect because the method of creating the oscillation varies with engine design or engineered methods, such as chain drive vs. internal cam drive or combined with electro magnets. While either method accomplishes the same thing, they are made differently. Full circle rotation of opposing magnets (like meshed gears) will not work because of timing needs require to much gearing resulting in excessive drag.

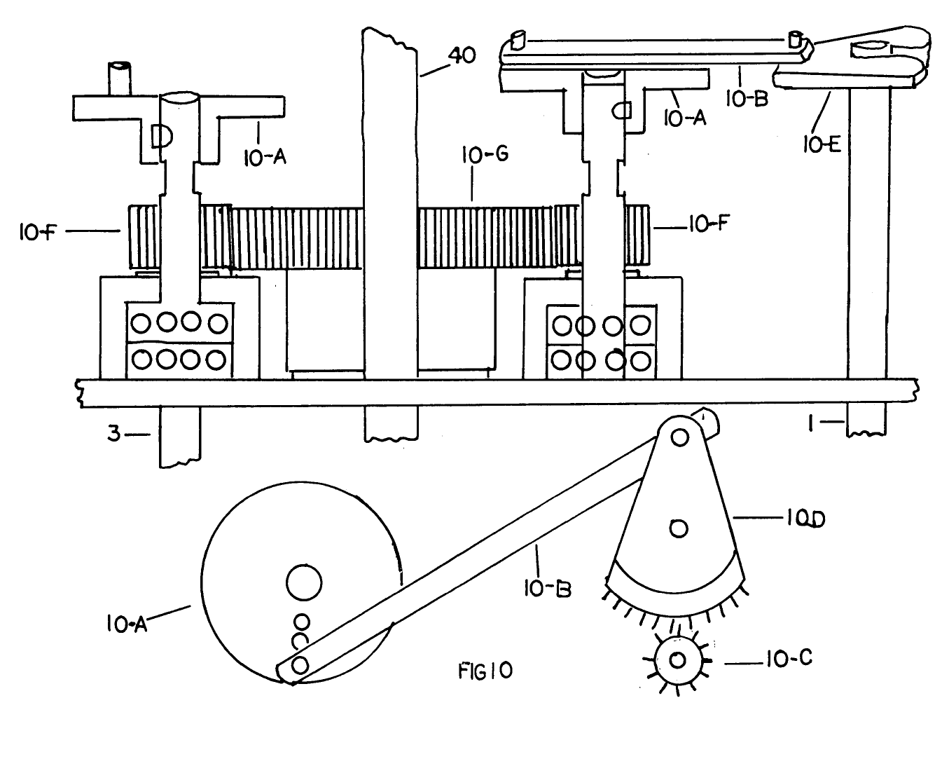

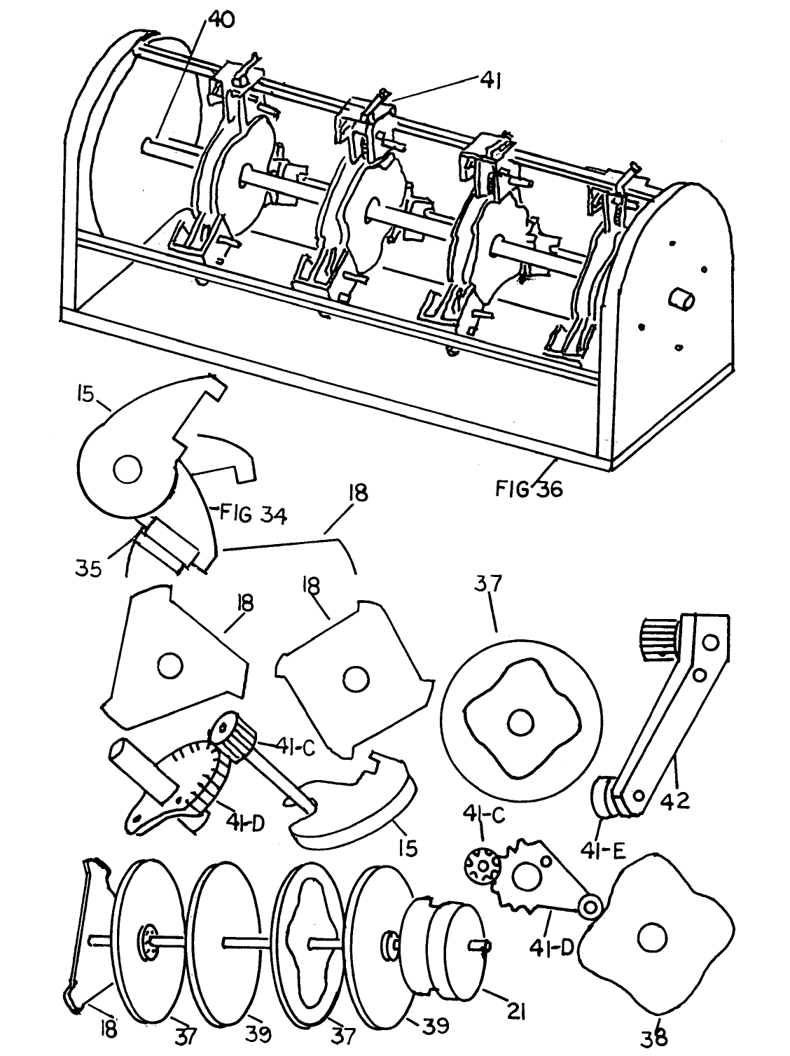

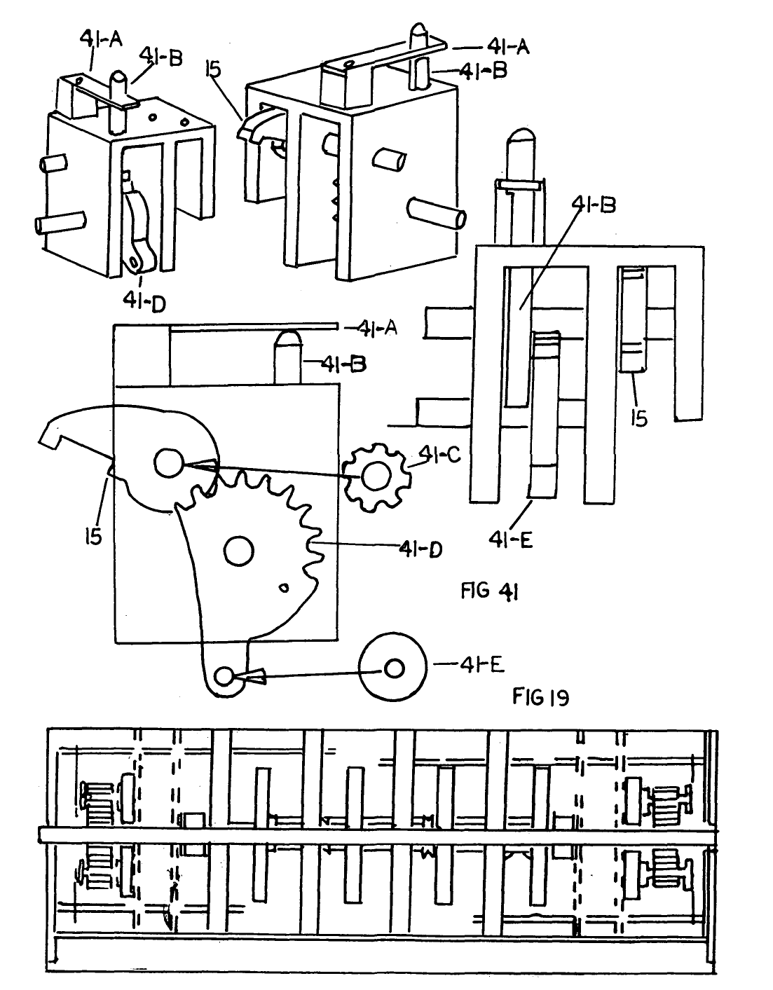

As you can see from the drawings, the engine can be made in at least 3 different ways as shown on drawings page 1, as one type; page 2 and FIG. 19 on page 6 as the second type and page 5 with FIG. 36 as being the 3rd type. In addition would be the variations using electro magnets combined with permanent or streight electro magnets. All of these are made a little different and drive a little different but the one common factor for each and all is the pulsating drive system, be it external cam, internal cam or chain drive, using permanent magnets, combined permanent magnets and electro magnets or streight electro magnets. They all have the same effect or near same functions to cause the oscillation, dwell, neutral and extended push with direct contact for maximum power from the magnets. Each style engine must have a means to tilt the paired magnets and/or electro magnets to keep them face to face. A pivit just above the arm magnet works well as does a piviting magnet seat and various other ways.

### BRIEF DESCRIPTION OF THE SEVERAL VIEWS OF THE DRAWINGS

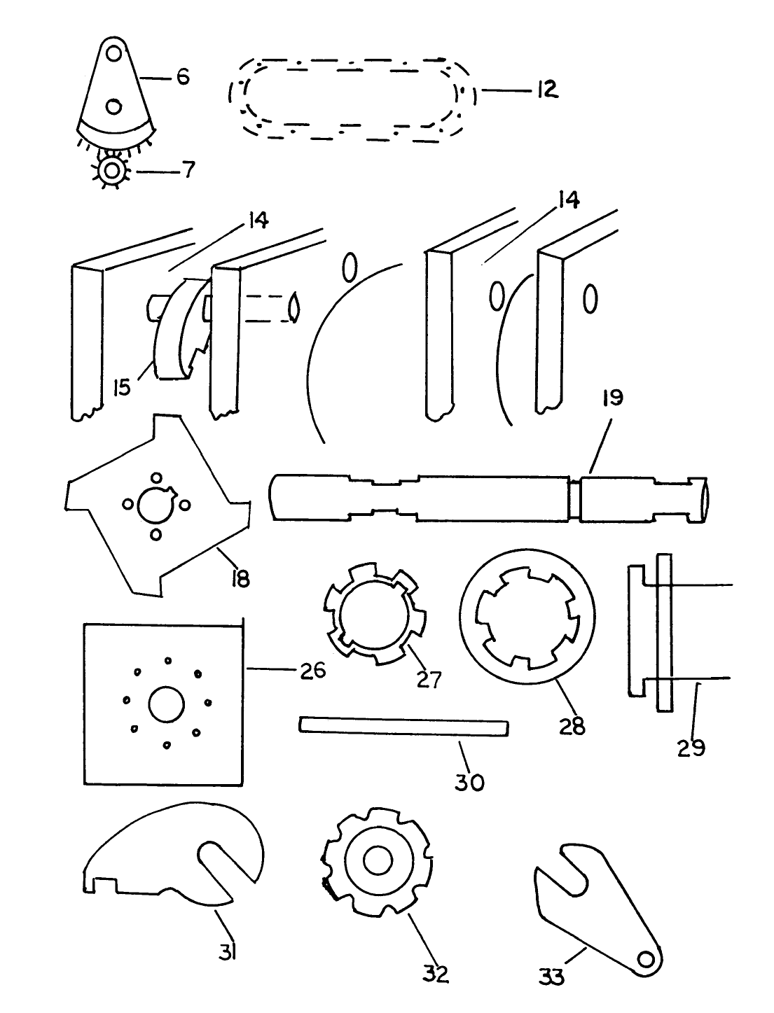

1. Drive rods numbered 1, for magnet carrier showing arrangement and timing sequence for the center gear box drive, three cam engine shown in FIG. 11

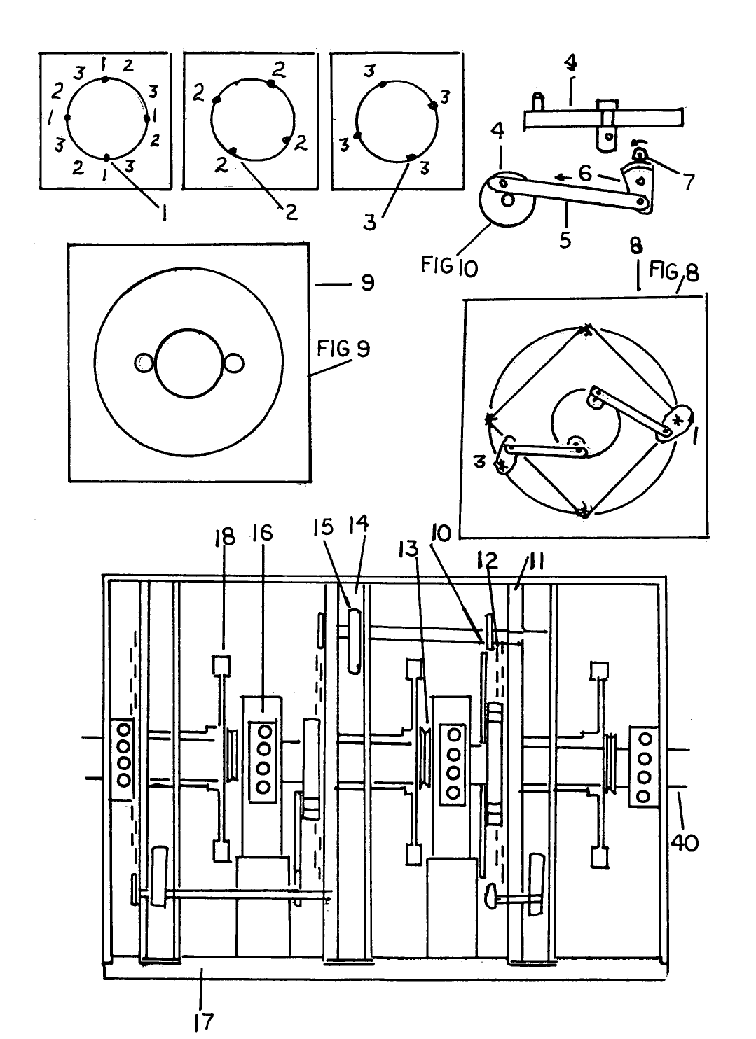

2. Drive rods numbered 2, showing their location. See FIG. 8 to show group drive.

3. Drive rods numbered 3, showing their location. See FIG. 8 to show group drive.

4. This is a side view of the disc in FIG. 10

5. Connecting arm or push arm between the oscillating disc and the bell crank FIG. 10

6. Bell crank gives adjustable speed control to magnet carrier rods when adjusted with positions on 4. Cam style is done by the cut of the cam configuration.

7. Opposing bell crank gear mounted on drive rod for magnet carrier

8. FIG. 8 shows the timing system. The center circle is the main shaft gear. The small circles with the arm attached to each is the counter gears with the oscillating plated mounted on them. The arms extend to the bell crank for all four rods numbered 1., which are tied together by chain and sprockets so as to work as one. The other arm goes to the bell crank of the number 3, drive rod. Note that the rod location as defined by the radius line places the second drive outside the area of the first chain drive, thus room to operate. The basis for the staggered timing of 1 and 3 on one end and 2 and 4 on the other. It is all about space to work. A like pattern is used with all three style engines to gain the same effects. Like meaning the shuffel of parts to gain the space needed.

9. Showing Rod radius (large circle) main shaft gear (medium circle) counter drive gears (small circles).

10. Drawing page 4 shows the full and complete system from main shaft gear of 10-G, counter shaft gears of 10-F, oscillating disc of 10-A, connecting arm or push arm between oscillating disc and bell crank of 10-B, opposing gear for drive shaft in bell crank 10-C, bellcrank 10-D, standard drive arm on drive rod that will not give the effects needed for the extended push and power of 10-E, magnet carrier drive rods 1, also 3, main drive shaft made of non-magnetic stainless steel of 40.

11. FIG. 11 is the complete assembly of the three disc, center gear box drive motor

12. Chain drive shown at each point where FIG. 10 is located.

13. Slide yoke assembly that would include 27,28,29 for this model and 20,21,22,23 of the model wth the end mounted gear boxes. There are many ways to do this.

14. Magnet carrier located between crossmembers shown for each rod on each crossmember. Magnets can be permanent or electro magnets.

15. Magnet carrier. See FIG. 34 page 5.

16. Main shaft support bearing.

17. Base plate serves as mounting platform.

18. Magnet disc. Can be made in differant numbered lobes. Magnets can be permanent or electro magnets.

19. Drive rod for magnet carriers showing details of mountings for arms.

20. Anchor block for slide assembly. Holds 4 rods in one position, the other 4 slide

21. Disengagement yoke for slide action.

22. Slide rod that remains in place.

23. Slide rods that ties all plates together as an assembly that slides.

24. Joint assembly of FIG. 10 in end mounted gear box. Joins 24 and 25 as opposit end of engine with a like set of gears and drives.

25. Counter gear of opposing end as part of gear boxes mounted on each end. Different styles and locations and numbers of gear boxes can vary with applications.

26. Anchor block is made up of three plates. The center plate is keyed to fit into the main shaft and serves as one of three points that drive the shaft from the disc. The two outside plates on this block sandwich the center plate, locking it in place on the shaft. The 4 rods that remain in place are mounted in a specific pattern of 22.5° holes with a total of 8 holes to be able to change it for timing if needed. There are different ways to do this same thing per application including a spline shaft and sleeve assembly.

27. A splined sleeve that fits over the main shaft, keyed to it that allows the 28 to fit over it as a slide rather than using rods. Both work very well. The rods are cheaper.

28. Outside splined sleeve that goes over 27 as a slide but that mounts the magnet disc in along with a yoke for sliding the unit to engage/dis-engage disc. (see 29)

29. Side view of 28, showing shoulder and yoke.

30. ⅜ inch brass rods used as slide assembly parts, each cut to length.

31. Additional style magnet carrier arm. Arms can vary in length and design.

32. Sprocket for drive chains used to tie 4 drive rods together so that they all work doing the same thing at the same time.

33. This style of magnet rod drive arm will not give the needed speed of the drive rod to stay with the magnet disc so as to have full contact pressure for 60% of the power stroke. This style as with others would need an anti-reversing mechanism to maintain a close or touching, face to face push.

34. FIG. 34 shows the progressive stages of the power stroke of the magnet carrier against the magnet on the magnet disc. It also shows the neutral position of the magnet carrier arm while in the upper dwell position.

35. Is the face to face position of the magnets at the end of the power stroke just before the dwell at the end of that stroke.

36. This is an assembly drawing of the same type engine that uses either internal cam followers or ex-ternal cam followers.

37. Disc showing pattern of internal cam. This pattern does the same thing for the dwell and neutral as the other style with the bell crank. However this style also uses the bell crank principal as shown in 42. In the end the effect is the same on the cam. (the difference is that the external or internal cams has more friction loss but less overall drag) The internal cam is the best choice of all.

38. Disc for external cam. See 37 above.

39. Disc shield to hold the internal cam in the slot. (not needed on some styles)

40. The main driveshaft shaft made of non-magnetic stainless steel. A magnetic shaft in any of the three models will cause it to not function. (if the distance from the shaft to nearest magnet is within the range of the magnetic field)

41. FIG. 41 is multipal views of the mechanism used to extend the length of power stroke and provide for the neutral position. Stroke can also be lengthened by using a longer magnet carrier arm.
41-A Fiberglass spring used to hold the cam follower of the external cam, down on the surface of the cam disc. It is also the stopping device used to stop the engine by lifting the arm from the cam surface.
41-B Pin connecting fiberglass spring to cam follower.
41-C Counter gear mounted on same shaft as Magnet Carrier Arm that makes for the high speed ratio in this model for either internal or external cams. This section can reduce the height of the drive cam lobe assisting in adjusting length of stroke.
41-D Cam follower serving as one end of a bell crank for external cams.
41-E Ball bearing that fits on the end of either style cam follower to lessen the friction.

42. Arm of internal cam follower. The size of gear and bearing can be changed to meet the ratio requirements at the gear box end of this style bell crank. The constant speed can be adjusted here as well as in the chain drive style engines.

### DESCRIPTION OF PULSATING MAGNET POWERED ENGINE

1. The pulsating permanent magnet engine gets it's power from the resistive force of magnetic poles of the same polarity as a form of magnatic repulsion. In so doing the tendancy for magnets to stick or cling together is eliminated, adding to the freedom for the disc, which the magnets are pushing, to rotate out of the path of the repelling force of the opposing magnets. These are high holding force, rare earth Neodymium, permanent magnets. They are available in a varied range of strength. The term “holding force” is the term by which the power of the specific magnet is determined or identified. It's power is at least equal or slightly greater in the repelling force but not identified that way.

2. The mechanical drive system of this engine can be accomplished by two (2) methods or three styles. The first method, shown by illistration and marked FIG. 11 and FIG. 19.—appearing on drawing pages numbered 1,2 and 6. Described as chain drive.

This first method is the first method herein described. The second method is shown by illistration and marked as FIG. 36 described as cam and cam follower model and appearing on page 5 and 6. The cam models have two styles; internal cam and external cam. The difference as end result is none because in the end both methods cause the rotation under power. Both methods have three points from which to drive accessories.(front and rear main shaft gears and the rear end of the main shaft.) The requirements of non-magnetic materials within the range of the magnet fields is the same in both models. On all of the models an anti-reverse mechanism can be installed on the drive shafts to help increase power. Anti reverse mechanisms on chain drive units are on each individual magnet arm shaft. On the internal and external styles the anti reverse mechanism is mounted on the main drive shaft.

A. The 1st. method is a pulsating drive using drive gears, drive plates, drive arms, (see FIG. 10) drive sprockets and chains (see FIG. 8 and FIG. 11) with drive shafts that have mounted magnet carriers in each of the 4 crossmembers.(see page 3 #14,15 and 12) Those carriers oscillate in time with the magnet carring drive discs magnets. The power comes from the repelling force of those groups of opposing magnets timed so that the magnet carriers and magnet discs can meet at specific times to match for their extended push. (see FIG. 34)

B. The 2nd method is also a pulsating drive but uses inside cams with cam followers. It can also use external cams with matching cam followers as illistrated. (pages 5,6 and FIG. 36) the effect is essentially the same but accomplished by an assembly of drive gears, cam followers,(41-C-D and 42) flat fiberglass springs,(41-A) and magnet carriers,(15) mounted in positions located about the circumference of the cam disc (37and 41) and the magnet disc, (39) which set side by side with a spacer for either style of cam followers. (FIG. 36) These assemblies are mounted so that the cam followers reach their specific cam and the magnet carriers in that assembly are timed with the magnet disc. The cam followers and magnet carriers are connected by shaft and gear drive and timed with that gear to match magnet carrier arms to magnet discs. (36) They accomplish the same thing as the 1P. version, crossmembers have rod carriers but it is harder to build and has a greater amount (20% more) of friction but less drag than the 1st. version.

Specifics of 1st. Version:

3. This engine uses no electricity in it's internal operation. Therefore there is no way to switch the engine on and off with a switch. To stop the engine, the contrasting poles must be seperated by sliding the rotating drive (magnet discs) away from the stationary magnet carriers located in the circumference of the four crossmembers. (see pgs. 5 &6 for 20,21,22,23 and/or 27,28,29) The slide is distanced so as to avoid the effects of the two contrasting clusters of magnets from having enough force to cause rotation. The engine will remain idle untill the magnet discs are slid back into the center of the crossmembers in line with the magnet carriers, thus causing rotation to occure. This sliding is accomplished with a lever, bearinged on a block at the rear end of the main shaft, ahead of the anchor block.(21 or 29) A solinoid could be used to engage the slide to travel in or travel out or as said, it can be done manually. If electricity is used for that solinoid it would be comming from a battery, but other than to engage or disengage the magnet discs slide, the battery would have no other effect on the engine.

In product development, it was found that the use of electro magnets along with permanent magnets is a good combination as is just streight electro magnets replacing all permanent magnets. In either instance the drive mechanisms are essentially the same, except for adaptation of the different type magnets. However if electro magnets are used, it would require at least a battery as a power source for the electro magnets but a great deal of the electrical power would come from it's own onboard generator system. Therefore if the electro magnets are used with this same or similar oscillating mechanism, there would be at least some electrical power used in the development of the horsepower rating for that particular engine.

4. This slide assembly consists of the main shaft of the engine;(40) two anchor blocks (20) that are designed to hold the 4 brass slide rods in a fixed position at the front of the engine and also at the rear of the engine.(22) There are a total of 8 rods in all.(22,23) 4 of those rods remain in the said stop blocks; the other 4 rods tie together all of the magnet discs. A matching block is also attached to the magnet discs.(21) These, attached, thicker blocks serve in part as the drive for the magnet discs with each block having a key way to match the keyway in the main shaft for the drive. Additionally the 8 rods also drive the discs but the discs do not have a keyway. The pattern of the rods and blocks allows for timing of the magnet discs to the magnet carriers in the crossmembers by rotating holes. (26)

5. This drive can also be accomplished and made to slide by using a splined shaft (27,28,29) rather than rods but it is far more expensive to make the splines to use, than it is to use the rods. Other than expense, the effect is the same, but the rods allows for a lighter weight main shaft while adding strength to that main shaft with the 8 rods. (rod diameter ¼″×8 rods=2″ of strength added)

6. The magnet carriers are where the engine gets it's name “pulsating”. Those carriers for the size engine using a 7½″ O.D. magnet disc drive, requires a total of 16 magnet carrier assemblies in all. (That number changes with the varied horsepower) That assembly is made up of a special designed hook shaped carrier (15) (design changes with length and mechanism used for face to face contact of magnets) that is seated and anchored to a drive shaft mounted thru the crossmembers. The drive shaft or rod, extends from a position in the circumference of the crossmembers (depending on which magnet disc it is timed to) and goes either to the front of the engine or the rear, as timed. The shaft will extend through two bulk heads that are spaced 2½″ (14) apart with holes aligned in the first bulkhead for a total of 8 shafts and in the second bulkhead, for 4 shafts. (FIG. 19) These shafts are driven in clusters or groups of 4 to match in time with the 4 lobes on the magnet discs. The shafts are also staggered in their position so that from one end of the engine will be driven shafts 1 and 3. (FIG. 8) On the other end of the engine the shafts will drive 2 and 4. (with this offset you gain room for the sprockets and chains that you could not otherwise accomplish) Each number has a group of 4 shafts which are driven by one chain for each group. Each group of 4 has one of the 4 as a drive point for the drive arm. The bulkheads are there to separate the chains and provide a pivit point of high strength for the drive arm, needed when the engine is turning and the pressure would be high on the said shaft, at the arm, to drive the sprockets, chains and pushers.

7. The drive arms are linked by a bar, (10-B) to a disc drive with a specific diameter, mounted on the counter shafts, with the link attached through a hole in the said disc and a hole in the drive arm.(FIG. 10) This drive disc causes the drive arm to travel less than half way around (160°) in the rotation of it's drive shafts. It is then brought back on the same arc, to it's original position as the drive disc turns. This process is repeated 4 times each revolution of the magnet disc, per drive arm. The drive arm oscillates causing the magnet carrier hook to do the same thing on the other end of the shaft. With the drive shafts of 4 in a group, all doing the same thing, pressure to repell is applied to all four lobes of the magnet disc at the same time. This is done by number as being first one magnet disc followed by another, causing a regular pulse of four contacts or pushes, per magnet disc, per revolution, per disc.(X 500 R.P.M.=torque) Expect 1750 RPM. (FIG. 8) Engine R.P.M. can be from 500 to 3000 depending on how the set up is done.

In the styles of the internal and external cam, the bellcrank assembly as described above in paragraph numbered 7. is accomplished by using cam followers on the surface of the cam and piviting to mesh at the drive gear on the second shaft of the magnet arm carrier gear box illustrated in FIG. 41 (all) The said disc and arms stated in paragraph 7. are eleminated.

8. There are three things going on to insure the rotation:

A. First the amount of pressure applied to each disc is constant so that the engine actually develops stall torque.

B. Second to insure that this pressure is constant the magnet carriers arms are made to arc in the oscillating process, to extend the push causing the rotation to be an overlap of lobe contacts which forces the rotation.(FIG. 34) In this instance we have power into the rotation by multiplying the numbers of positions involved, related to the pressure each position sets forth. On this size magnet disc, the stall torque is computed to be 256 foot pounds as stall torque and 1024 foot pounds of torque in each revolution, with the combined force at each lobe being 16 pounds. This 256 pounds of pressure, times the four times per revolution is what causes the main shaft to turn. The amount of friction and gear drag amounts to about 15 pounds per revolution, offset by weight of each of the gears, discs, slide mechanisms and their momentums. (applied centripetal force) It is important to use a piviting end on the magnet carrier arms to keep the magnets face to face during the greater percentage of the push stroke.

C. The third thing is that that power is transferred back thru the main shaft to a keyed gear at both ends of the engine, with a counter gear set at a ratio of 4:1 off that main shaft gear. The counter gear is connected by shaft to a drive disc, fastened directly over it, that oscillates the magnet carriers, drive arm. That engine can not stop because it is under new energy from each repelling push of each lobe, of each magnet disc, to their respective counter magnets, held in the timed opposing carriers. By so doing, the length of the stroke of the magnet carrier (about 1½″ arc or push) keeps the pressure on the push at the full 16 pounds, through the entire 1½″ push, for each lobe and all 4 discs. Otherwise the full pressure would only be for about ¾″×4 discs or 3″, applied to the distance of 5⅞″ between lobes, which makes the 3″ fall short of allowing the continued 256 pounds of pressure to be applied for the full distance of travel from one lobe to another.(FIG. 34) Full time pressures are required for stall torque. That pressure would drop as the distance between magnets, per lobe, increased with the rotation. (without the extended push) While rotation would still happen, the loss of power would be greater than desired. Calculation of the length of arm for length of stroke should be applied here to meet the needs of the stroke and power.

D. To be clear, the distance between lobes is 5⅞″. To supply full power thru that entire distance between lobes, all 4 magnet discs are pushing 1½″ each, in pulse, in what amounts to a quarter turn or 5⅞″ between lobes of the 4 lobe discs. The actual distance they push in that quarter turn is 6″ which is slightly overlapping the distance between lobes by ⅛″. Thus there is no gap or space at any point in a full revolution that is not under full power of the available energy. Therefore untill you would cause the main drive shaft to be over-loaded in excess of the 256 foot pounds of torque, the load would not stall the engine. If you did exceed the 256 foot pounds, the engine would stall untill the load was reduced to 256 foot pounds or less and then it would start rotating again because those pressures applied to that main shaft are constant. The typical gasoline or diesel engine, when stalled, would die and have to be started again. This permanent magnet engine would simply start rotating again as soon as the load was reduced to or below the 256 foot pounds of stall torque or the transmission dis-engaged, as relates to this particular size engine.

9. The function of this engine's main shaft speed will range in speed from 500 R.P.M. to 3000 R.P.M. depending on how it is set up, but it is a constant speed at whatever the speed. To vary the speed as a varable speed engine similar to a gasoline or diesel engine, requires either the use of a varable speed drive on a counter shaft or coupled with a generator and electrical sub assemblies controlled by reistat. Also done by a hydraulic pump with hydrostat control, as a unit to be coupled between the engine and a transmission. Changing speed by connecting the main shaft with a hydraulic pump that is controlled by hydraulic spools or hydrostat is the best method but it uses a lot of the engines power in just pumping the oil. However there would be available speeds from—0-up to 3000 R.P.M. instantly, which would allow the use of the ordinary vehicle or equipment transmissions currently in use. Component strength is important to be considered with this method because of the high torque and the damage the rapid acceleration could have on the transmission and vehicle drive line. Keep in mind that the rate of torque is 3.5 times greater in this engine than it is in a gasoline or diesel engine of the same rated horsepower.

10. Therefore if this magnet engine is rated at 45 horsepower it would take a gas or diesel engine rated at 157.5 horsepower to do the same work. This magnet engine is rated the same as an electric motor at 3.5 times stronger than compared gas or diesel motors of the same horsepower. Close examination of this magnet engine shows it to be the same as an electric motor without the cord. This is done by using permanent magnets in place of electro magnets with the many problems of controlling magnetic waves you can't shut off nor resist with shields or insulators nor switches nor comentators with carbon brushes. The end result, once the magnet currents are contained, the permanent magnets supply the same power as an electro—magnet motor though it is totally different in it's mechanical parts and function. The power comming from the Rare Earth Neodymium magnets that permanently hold their power for an unknown period of time but at least 60 years, can range in magnet power from 3 pounds of holding force up to 180 pounds of holding force. Depending on the size of the magnets and numbers used, the engines can be built from a low 15 horsepower, to up into several thousand horsepower, all of which are similar in structure but vary greatly in demensions inside and out. None use any type of fuel or battery to power them. As of this time, minature sized engines can not be built. This is due to absence of materials necessary for resistance to megnetic waves resulting in a requirement of greater spacings between magnets. That additional space is needed to allow rotation, free of interference from nearby magnets that would lock the rotation. The result is larger units are all that is currently available. However, ongoing research is likely to produce that material at any time.

In the above paragraph number 10, is state no electrical or fuel is used in this engine at this time. In the development of this engine it was determined that the use of electro magnets combined with permanent magnets or streight electro magnets that uses the same oscullating or pulsating bellcrank system will work and does aid in the development of horse power. If streight electro magnets are used, it is possible to reduce the size of the engine. All of which requires a power source such as a battery if the electro magnets are used. In addition the onboard electric generating system can also be used along with or independent of the battery power.

11. All components within or between the areas of the bulkheads on each end that includes the center part of the engine, that separates the slide assembly, crossmembers and magnet clusters from the drive gears and chains, must be made of totally non-magnet materials. (Aluminum, non-magnetic stainless steel, brass, bronz, phenolic, neopreme) The covers and bulkheads are also non magnetic, inside and outside of the engine. Distance must be calculated to maintain a distance slightly greater than the reach of the magnetic waves from inside so that those wave lengths will not reach through the covers of the engine. This will insure that no outside forces or magnetic materials will interfear with the engine rotation if the engine magnets can not reach that far to draw from that outside force or magnetic material. All magnets have their wave length limits but they must be respected if the engine is going to keep running. One material that does reduce the magnetic field distances is corrugated cardboard. It appears the air space in the corrugation breaks the magnetic wave continuity thus limiting the distance of the wave length. (It must be kept dry)

12. There are several factors that nust be known to insure rotation. Without applying these principles the engine will fail to run or be very weak. This is true no matter which version or model is used. They must be known and followed.

13. The distance of the magnetic waves must be known. The power of the magnet in terms of holding force must be known. No materials within the distance of the reach of the magnetic fields can be magnetic or capable of attracting a magnet. Not even one of the smallest metal set screws that will attract a magnet can be used. If you do it will lock the rotation of the engine.

14. To learn the strength of the magnets to be used, ask the supplier for that information. Then take two (2) of those chosen magnets and place them in an area where they are not close to anything that will attract a magnet. Space them several inches apart on a flat surface. When you do this test, place the magnets in at least three different arrangements. The first would be standing the magnets on edge facing face to face with the poles of the magnets of the same pole facing each other. The second would be to stand the magnets on edge, facing each other face to face with the other pole sides facing each other. In other words the first time the S side of the magnets would face, the second time the N side would face. The third time the S would be facing the N side.

Take a light weight needle on a piece of thread of about one foot long, when doubled. With this needle and thread, dangle the needle so it is between the magnets but does not touch the flat surface of the platform. The needle will be attracted to one end or the other if the magnets are to close. You should have about one (1) inch of area between those magnets (centered) that the needle is not effected by the magnets. That distance from the face of one magnet to the face of the opposing magnet, on the facing side, is the distance needed to space your setting when building the engine using that power of magnet. A change of power in magnet strength will change the distance needed. Do not mix sizes. When you do your test you will find that some positions will push the needle while others will pull it. You want to use the distance that is the greatest so that it will not be to close to work. Test each batch before use. Some times the strength of a specific size will vary. You need to know that.

15. When you determine the distance that is outside the magnetic field, it is that distance or greater that you must use to build with. For example; a magnet rated at 15 pounds holding strength might require a distance of at least 7 inches between magnets to work. With that determine the number of lobs you want to use on the magnet plate (disc). (Keep in mind that at some point you must calculate the stroke between the lobs with the length of travel of the magnet holder arm so that you have full stroke conditions at all times.) If you are using a four (4) lobe disc multiply the 7 inches times 4 or a total of 28 inches is then the circumference of the disc you will be using. Divide that by pie (3.1417) for the diameter (8.9″) and divide that by 2 for your radius (4.456″) These are all dimensions you will need as you build. Streight line measure.

16. To determine the rod radius, you determine the length of the magnet carrier arm that runs from the drive rod to the magnet base on the magnet disc. An overall length of about 3 inches would provide for the height of the magnet in the disc, the clearance between the disc and the opening in the crosmember of ¼″ (0.250′) and the clearance needed for the arm to lift up to a neutral position within the crossmember. You must have the room for that neutral position or the magnets will stick as they try to pass each other and the rotation will not occure. That requires about a 140° degree position from direct line running from drive rod center to center of the magnet in the disc. The location as far as angle goes, of the magnets in the disc, is also important for rotation and the neutral position. This is a position that has to be adjusted when assembled because the magnet carrier arm must clear the magnet on the disc and that clearance will change with the length of the said arm and clearance. What happens is that the magnetic field that comes off the side of the magnetic is opposite of the face of the magnet. So to avoid sticking of the magnets together the angle must be adjusted so that there is a neutral position that allows the magnet carrier arm to pass over the disc magnet without sticking. Therefore the distance from the magnet on the disc to the center of the drive rod will be about 2¾″ making the Rod radius the sum of 2.75″ plus 4.456″=7.206″ radius for the rods to be centered on. The number of magnet disc to be used is then determined and standard would be three (3). Since there are 4 lobs on the disc and the division is of even numbers; 4 lobs, 4 contacts per revolution, that equates to 16 rods needed to drive the 3 disc to make 4 contacts per revolution. This means that the location of the drive rods would be found by using a full circle of 360 degrees and dividing it by 16 rods which equals 22.5 degrees between rod centers in the circumference of that rod radius and out 7.206″ from center of engine main shaft. With this information we know that there must be clearance at the top of the crossmembers to allow the magnet arms to extend nearly streight up to gain the neutral position. Thus we add to that radius of 7.206″ the length of the magnet arm (3″) plus 3″ clearance, which equals 13.206″ from center of main shaft to top of crossmember. Add to that 1/16″ aluminum sheet, ¼ (0.250″) corrugated cardboard an ⅛″ (0.125″) aluminum sheet for cover which=14.206″×2=28.412 as height of engine. (This can be reduced in size depending on how close magnetic materials will be.)

I claim as the invention:

1. The Pulsating Permanent Magnet Powered Engine converts magnet force fields into a new energy source by use of a system called a bellcrank assembly that as a manufactured item, is characterized by it's improvments in clean, economical, engine power suitable for use throughout the industry, as replacements to most any application where engines powered by gasoline, diesel fuel or electricity are used, making it suitable for almost any application in the industry.

2. The pulsating permanent magnet powered engine of claim 1, wherein the improvment comprises principles of prior arts with new functions to get it's power from opposing magnets, not from fuel or electricity but thru the functions of a bellcrank system, made suitable to the style of the respective engine, so that it replicates the stroke of a piston found in internal combustion engines and combines that function with the applied principles similar to the functions of electric motors.

3. The bellcrank system of claim 2, develops high torque output in those magnet powered engines that use the bellcrank system, which achieves torque ratings, similar to an electric motor.

4. The bellcrank system of claim 2, has an effect on the engine unlike the piston stroke of the gasoline or diesel engines, allowing for the development of stall torque by enabling the use of incrementally progressive timing of the match of magnet carrier arm magnets and magnet carrier disc magnets, in a fashion that leaves no part of the rotation of the permanent magnet powered engines, without minimal torque power, no matter which position the stall would occure in.

5. The permanent magnet powered engine of claim 2, with it's bellcrank assembly function is used to develop high torque power in engines with chain drives, external cam drives, and internal cam drives with all their varied styles of engines.

6. With the permanent magnets, from claim 2, combined with the bellcrank system function of oscillation and using the magnets repelling force, enables the points of dwell and neutral points necessary for the rotation of the engine without the magnets sticking or clinging together and provides for the extension of the power stroke of the magnet carrier arm in force against the magnet carrier discs at the end of the stroke, as the magnet carrier disc rotates away from the magnet carrier arm.

7. The bellcrank system of claim 2, and it's versatility, allows the use of various sizes of magnets and also various numbers of magnets, used in combination with various numbers of drive disc, to develop horse power ranges from very low horse power to very high horse power.

8. This magnet power conversion of claim 2, with it's bellcrank system functions in engines made of non magnetic parts and materials or in engines built with mostly magnetic type parts and materials with respect to the limits set by magnetic force fields.

9. The magnet carrier disc and carrier arms of the permanent magnet powered engine in claim 2, requires face to face contact of the magnets using a piviting mount(s) on the magnet seat(s) of either the magnet carrier arm or the magnet carrier disc or both to achieve the required face to face contact for maximum power during each stroke and provides for an extended push of lesser power as the opposing magnets separate through rotation of the magnet carrier disc.

10. The magnet carrier disc of the permanent magnet powered engine of claim 2, serves as both a drive disc and also as a cooling fan inside the engine.

11. In claim 2, the length of stroke of the magnet carrier arm of the permanent magnet powered engine is directly proportionate to the disc diameter so as to determine the span of the power stroke as is related to the distance between the magnets on that disc and the number of disc times the length of the stroke to insure that those combined strokes will span that distance between the magnets on the disc, thus insuring rotation and stall torque.

12. The revolutions per minute, of the permanent magnet powered engine of claim 2, as a constant engine speed, is controlled by the gear ratios and cam configurations which regulates the magnet carrier arms and the magnet carrier discs, which applies the functions of the bellcrank system and it's many calculations, making for proper preformance of the engine, at the desired revolutions of the engine main shaft.

13. The mechanism used to engage and disengage the magnet carrier discs in claim 2, can be made more than one way mechanically or electrically, to allow for the sliding action to occure that starts and stops the engine, at the same time strengthening the main drive shaft by it's design of slide rods and/or splined sleeves.

14. The versatility of the bellcrank system in the permanent magnet powered engine of claim 2, makes for the various engine designs of chain drive, internal cam drives and external cam drives, to be altered or modified, to accommodate installation of various types and combinations of magnets, including the use of all permanent magnets, made of any material, in the specific size, make or form, all electro magnets of any specific size, make or form and also a combination of these same permanent magnets and electro magnets together in their various sizes and forms, that functions in a manner that develops the desired new source of energy that would be provided by these various altered or modified style engines in the same fashion as the basic pulsating permanent magnet powered engine of claim numbered 1.
